(19) United States
(12) Patent Application Publication
(10) Pub. No.: US 2024/0396430 A1
(43) Pub. Date: Nov. 28, 2024

(54) COMMON-MODE VOLTAGE CANCELLER

(71) Applicants: DENSO CORPORATION, Kariya-city (JP); NATIONAL UNIVERSITY CORPORATION HOKKAIDO UNIVERSITY, Sapporo-shi (JP)

(72) Inventors: Atsuyuki HIRUMA, Kariya-city (JP); Satoshi OGASAWARA, Sapporo-shi (JP)

(73) Assignees: DENSO CORPORATION, Kariya-city (JP); NATIONAL UNIVERSITY CORPORATION HOKKAIDO UNIVERSITY, Sapporo-shi (JP)

(21) Appl. No.: 18/796,564

(22) Filed: Aug. 7, 2024

Related U.S. Application Data
(63) Continuation of application No. PCT/JP2023/002445, filed on Jan. 26, 2023.

(30) Foreign Application Priority Data
Feb. 9, 2022 (JP) 2022-019120

(51) Int. Cl. H02M 1/12; H02M 1/15; H02M 1/44

(52) U.S. Cl. CPC H02M 1/123; H02M 1/126; H02M 1/15; H02M 1/44

(57) ABSTRACT

A common-mode voltage canceller cancels a common-mode voltage that is generated in accompaniment with operation of an inverter that converts direct-current power to alternating-current power. The common-mode voltage canceller includes a common-mode transformer that generates a cancellation voltage that has a polarity reverse to the common-mode voltage. The common-mode transformer is disposed on a direct-current power line that supplies the direct-current power to the inverter.

### CROSS-REFERENCE TO RELATED APPLICATIONS

The present application is a continuation application of International Application No. PCT/JP2023/002445, filed on Jan. 26, 2023, which claims priority to Japanese Patent Application No. 2022-019120, filed on Feb. 9, 2022. The contents of these applications are incorporated herein by reference in their entirety.

### BACKGROUND

### Technical Field

The present disclosure relates to a common-mode voltage canceller that cancels a common-mode voltage generated in accompaniment with operation of an inverter.

### Related Art

A common-mode voltage canceller that cancels separately, for each phase, a common-mode voltage generated by an inverter using three common-mode transformers is known. In the common-mode voltage canceller, these common-mode transformers are disposed in three-phase lines between the inverter and a motor to cancel separately, for each phase, the common-mode voltage generated in the three-phase lines.

### SUMMARY

One aspect of the present disclosure provides a common-mode voltage canceller that cancels a common-mode voltage that is generated in accompaniment with operation of an inverter that converts direct-current power to alternating-current power. The common-mode voltage canceller includes a common-mode transformer that generates a cancellation voltage that has a polarity reverse to the common-mode voltage. The common-mode transformer is disposed on a direct-current power line that supplies the direct-current power to the inverter.

### BRIEF DESCRIPTION OF THE DRAWINGS

In the accompanying drawings:

FIG. 1 is a circuit diagram illustrating a motor drive system;

FIG. 2 is a perspective view of a transformer corresponding to one phase among common-mode transformers;

FIG. 3 is a graph illustrating a relationship between a coupling coefficient of the common-mode transformer and motor torque;

FIG. 4 is a circuit diagram illustrating a motor drive system in conventional technology;

FIG. 5 is a circuit diagram illustrating stray capacitance in an inverter;

FIG. 6 is a circuit diagram illustrating an equivalent circuit of common-mode voltage and cancellation voltage in conventional technology

FIG. 7 is a circuit diagram illustrating an equivalent circuit of common-mode voltage and cancellation voltage;

FIG. 8 is a circuit diagram illustrating an equivalent circuit that is a modification of the equivalent circuit in FIG. 6;

FIG. 9 is a circuit diagram illustrating an equivalent circuit that is a modification of the equivalent circuit in FIG. 7;

FIG. 10 is a circuit diagram illustrating a modification of the motor drive system;

FIG. 11 is a circuit diagram illustrating another modification of the motor drive system;

FIG. 12 is a circuit diagram illustrating another modification of the motor drive system; and

FIG. 13 is a circuit diagram illustrating a modification of the motor drive system and the common-mode voltage canceller.

### DESCRIPTION OF THE EMBODIMENTS

Conventionally, there is a common-mode voltage canceller that cancels separately, for each phase, a common-mode voltage generated by an inverter using three common-mode transformers (see the following non-patent literature (NPTL) 1).

### NON-PATENT LITERATURE

[NPTL 1] The Institute of Electrical Engineers of Japan, “Electromagnetic Environment/Semiconductor Power Conversion Joint Study”, Dec. 11, 2020, pages 21 to 26.

In the common-mode voltage canceller described in NPTL 1, these common-mode transformers are disposed in three-phase lines between the inverter and a motor to cancel separately, for each phase, the common-mode voltage generated in the three-phase lines. Incidentally, leakage inductance is present in the common-mode transformer.

Therefore, if the common-mode transformers are disposed in the three-phase lines, an alternating-current voltage of the three-phase lines drops as a result of the leakage inductance and voltage utilization rate of the inverter may decrease. In particular, a motor that is mounted in an electric aircraft tends to have multiple poles for weight reduction, and be driven at a high frequency and have low inductance. Therefore, the motor is easily affected by the drop in alternating-current voltage even by a slight leakage inductance.

It is thus desired to provide a common-mode voltage canceller that can improve a voltage utilization rate of an inverter.

A first exemplary embodiment of the present disclosure provides a common-mode voltage canceller that cancels a common-mode voltage that is generated in accompaniment with operation of an inverter that converts direct-current power to alternating-current power, the common-mode voltage canceller including a common-mode transformer that generates a cancellation voltage that has a polarity reverse to the common-mode voltage. The common-mode transformer is disposed on a direct-current power line that supplies the direct-current power to the inverter.

As a result of the above-described configuration, the common-mode voltage canceller cancels the common-mode voltage that is generated in accompaniment with operation of the inverter that converters direct-current power to alternating-current power.

Specifically, the common-mode voltage canceller includes the common-mode transformer that generates a cancellation voltage that has a polarity reverse to the common-mode voltage. Therefore, the common-mode voltage generated in accompaniment with operation of the inverter can be cancelled by the cancellation voltage generated by the common-mode transformer.

Here, the common-mode transformer is disposed on the direct-current power line that supplies direct-current power to the inverter. Therefore, even if leakage inductance is present in the common-mode transformer, a drop in alternating-current voltage due to leakage inductance of the common-mode transformer can be suppressed. In addition, the direct-current power supplied through the direct-current power line is not affected by voltage drop due to leakage inductance. Consequently, a voltage utilization rate of the inverter can be improved. Furthermore, for example, whereas three phase lines are required to be passed through a core when the common-mode transformer is disposed on three-phase lines in a configuration in which the inverter outputs to three phases, two direct-current power lines may be passed through the core. Consequently, a cross-sectional area of wiring to be passed through a core can be reduced. The core of the common-mode transformer can be reduced in size.

Specifically, as according to a second exemplary embodiment of the present disclosure, the common-mode voltage canceller can have a configuration as a passive common-mode voltage canceller including a passive component connected to the common-mode transformer.

In addition, as according to a third exemplary embodiment of the present disclosure, the common-mode voltage canceller can have a configuration as an active common-mode voltage canceller including an active component connected to the common-mode transformer. According to a fourth exemplary embodiment of the present disclosure, the common-mode transformer includes a primary coil to which a voltage correlated with the common-mode voltage is inputted and a secondary coil that outputs the cancellation voltage to the direct-current power line.

As a result of the above-described configuration, when the common-mode voltage is generated, the cancellation voltage can be outputted to the direct-current power line from the secondary coil of the common-mode transformer, and the common-mode voltage can be cancelled.

When the inverter outputs alternating-current power to N phases, the common-mode voltage Vc is a voltage in which a sum of the voltages of the phases is 1/N. Here, N may be a positive integer equal to or greater than 2, such as N=3. Therefore, by generating the cancellation voltage in which the voltage of the phases is 1/N and that has a polarity reverse to the common-mode voltage, the common-mode transformer can cancel the common-mode voltage by the cancellation voltage.

In this regard, according to a fifth exemplary embodiment of the present disclosure, the inverter outputs alternating-current power to N phases, and a turn ratio of the primary coil and the secondary coil is N:1. Here, N may be a positive integer equal to or greater than 2, such as N=3. Consequently, the common-mode transformer can generate, in the secondary coil, the cancellation voltage in which the voltage inputted to the primary coil is 1/N and that has a polarity reverse to the common-mode voltage, and can cancel the common-mode voltage by the cancellation voltage.

The above-described exemplary embodiments of the present disclosure will be further clarified through the detailed description herebelow, with reference to the accompanying drawings.

An embodiment implementing a motor drive system will hereinafter be described with reference to the drawings.

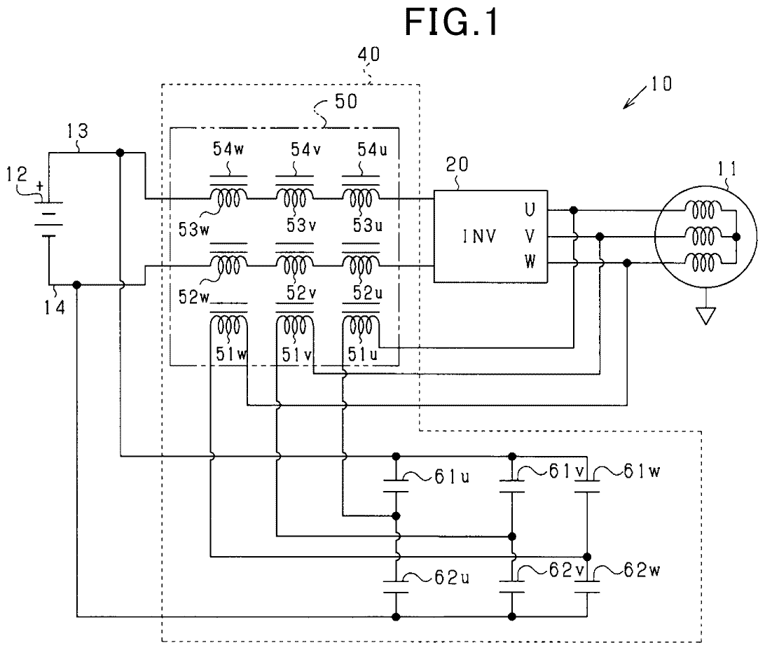

As shown in FIG. 1, a motor drive system 10 includes a three-phase motor 11, a power supply 12, an inverter 20, a common-mode voltage canceller 40, and the like. For example, the power supply 12 may be a battery that supplies direct-current power.

The inverter 20 converts direct-current power to alternating-current power and outputs the alternating-current power. Specifically, the inverter 20 repeatedly outputs a pulsed voltage from three output terminals U, V, and W in succession.

The common-mode voltage canceller 40 includes a common-mode transformer 50 (passive component) and six Y capacitors 61u, 62u, 61v, 62v, 61w, and 62w (passive components). The common-mode voltage canceller 40 is configured by passive components and is a passive common-mode voltage canceller.

One terminal of each of the Y capacitors 61u, 61v, and 61w is connected to a positive-electrode-side direct-current power line 13. Another terminal of each of the Y capacitors 61u, 61v, and 61w is connected to one terminal of each of the Y capacitors 62u, 62v, and 62w. Another terminal of each of the Y capacitors 62u, 62v, 62w is connected to a negative-electrode-side direct-current power line 14. That is, a series connection body of Y capacitors 61u and 62u, a series connection body of Y capacitors 61v and 62v, and a series connection body of Y capacitors 61w and 62w are connected in parallel between the direct-current power line 13 and the direct-current power line 14.

The common-mode transformer 50 includes a primary coil 51u, secondary coils 52u, 53u, and a core 54u corresponding to a U phase of the inverter 20, a primary coil 51v, secondary coils 52v, 53v, and a core 54v corresponding to a V phase of the inverter 20, and a primary coil 51w, secondary coils 52w, 53w, and a core 54w corresponding to a W phase of the inverter 20.

One end of the primary coil 51u is connected to an output terminal U of the inverter 20, and another end of the primary coil 51u is connected to a connection point between the Y capacitor 61u and the Y capacitor 62u. A first end of the secondary coil 52u is connected to a negative input terminal of the inverter 20, and a second end of the secondary coil 52u is connected to a first end of the secondary coil 52v. A first end of the secondary coil 53u is connected to a positive input terminal of the inverter 20, and a second end of the secondary coil 53u is connected to a first end of the secondary coil 53v. A turn ratio between the primary coil 51u and the secondary coils 52u and 53u is 3:1:1. A transformer corresponding to the U-phase of the inverter 20 is configured by the primary coil 51u, the secondary coils 52u and 53u, and the core 54u.

One end of the primary coil 51v is connected to an output terminal V of the inverter 20, and another end of the primary coil 51v is connected to a connection point between the Y capacitor 61v and the Y capacitor 62v. A second end of the secondary coil 52v is connected to a first end of the secondary coil 52w. A second end of the secondary coil 53u is connected to a first end of the secondary coil 53w. The turn ratio between the primary coil 51v and the secondary coils 52v and 53v is 3:1:1. A transformer corresponding to the V-phase of the inverter 20 is configured by the primary coil 51v, the secondary coils 52v and 53v, and the core 54v.

One end of the primary coil 51w is connected to an output terminal W of the inverter 20, and another end of the primary coil 51w is connected to a connection point between the Y capacitor 61w and the Y capacitor 62w. A second end of the secondary coil 52w is connected to the negative-electrode-side direct-current power line 14. A second end of the secondary coil 53w is connected to the positive-electrode side direct-current power line 13. The turn ratio between the primary coil 51w and the secondary coils 52w and 53w is 3:1:1. A transformer corresponding to the W-phase of the inverter 20 is configured by the primary coil 51w, the secondary coils 52w and 53w, and the core 54w.

The transformer corresponding to the U-phase, the transformer corresponding to the V-phase, and the transformer corresponding to the W-phase of the inverter 20 (common-mode transformer 50) are configured as a single transformer unit. The common-mode transformer 50 is disposed (inserted) on the direct-current power lines 13 and 14 that supply direct-current power to the inverter 20.

Here, the primary coil 51u, the secondary coils 52u and 53u, and the core 54u, the primary coil 51v, the secondary coils 52v and 53v, and the core 54v, and the primary coil 51w, the secondary coils 52w and 53w, and the core 54w are interchangeable. The series connection body of Y capacitors 61u and 62u, the series connection body of Y capacitors 61v and 62v, and the series connection body of Y capacitors 61w and 62w may be connected not only between the power supply 12 and the common-mode transformer 50 on the direct-current power lines 13 and 14, but also between the common-mode transformer 50 and the inverter 20.

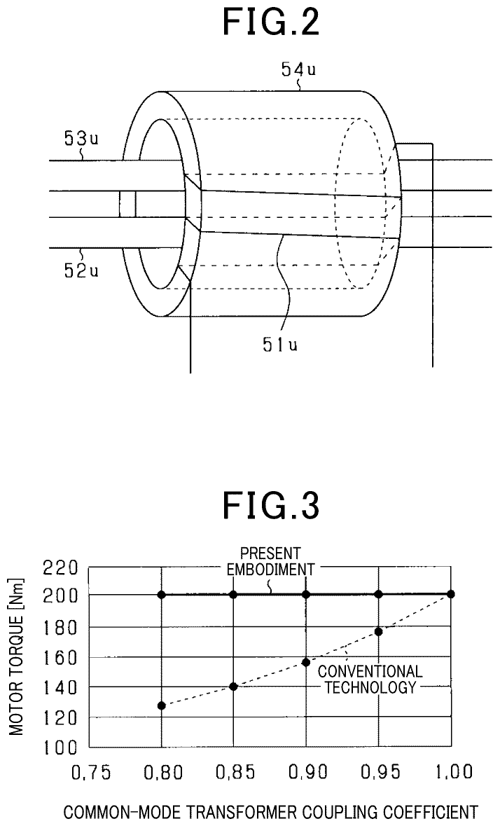

FIG. 2 is a perspective view of a transformer corresponding to one phase of the common-mode transformer 50. Here, the U phase will be described as an example.

The primary coil 51u is wound three times around the core 54u having a circular cylindrical shape. The secondary coils 52u and 53u pass through the core 54u. That is, the primary coil 51u, the secondary coils 52u and 53u, and the core 54u form a through-type transformer, and the turn ratio between the primary coil 51u and the secondary coils 52u and 53u is 3:1:1.

The primary coil 51u is excited in response to the output voltage of the inverter 20. When phase voltages Vu, Vv, and Vw are output to the respective phases, a common-mode voltage Vc is expressed by an expression below.

$$Vc = Vu / 3 + Vv / 3 + Vw / 3$$

For example, when the inverter 20 outputs the phase voltage Vu, the common-mode voltage Vc=Vu/3 may be generated. At this time, the phase voltage Vu is inputted to the primary coil 51u, and the secondary coils 52u and 53u generate a cancellation voltage Vr=−Vu/3. As a result, the common-mode voltage Vc is cancelled in advance by the cancellation voltage Vr on the input side of the inverter 20 rather than the output side of the inverter 20.

FIG. 3 is a graph of a relationship between a coupling coefficient of the common-mode transformer and motor torque.

In conventional technology in which the common-mode transformer is disposed in the three-phase lines between the inverter 20 and the three-phase motor 11, the motor torque decreases as the coupling coefficient of the common-mode transformer becomes smaller than 1.00. This is because the phase voltage output by the inverter 20 to the three-phase lines is an alternating current and the phase voltage drops due to leakage inductance of the common-mode transformer.

In contrast, according to the present embodiment in which the common-mode transformer 50 is disposed on the direct-current power lines 13 and 14 between the power source 12 and the inverter 20, the motor torque does not decrease even if the coupling coefficient of the common-mode transformer becomes smaller than 1.00. This is because the input voltage inputted to the inverter 20 through the direct-current power lines 13 and 14 is a direct current and is not subject to voltage drop due to the leakage inductance of the common-mode transformer.

Next, the present embodiment being capable of reducing a winding cross-sectional area in the common-mode transformer 50 compared to the conventional technology will be described.

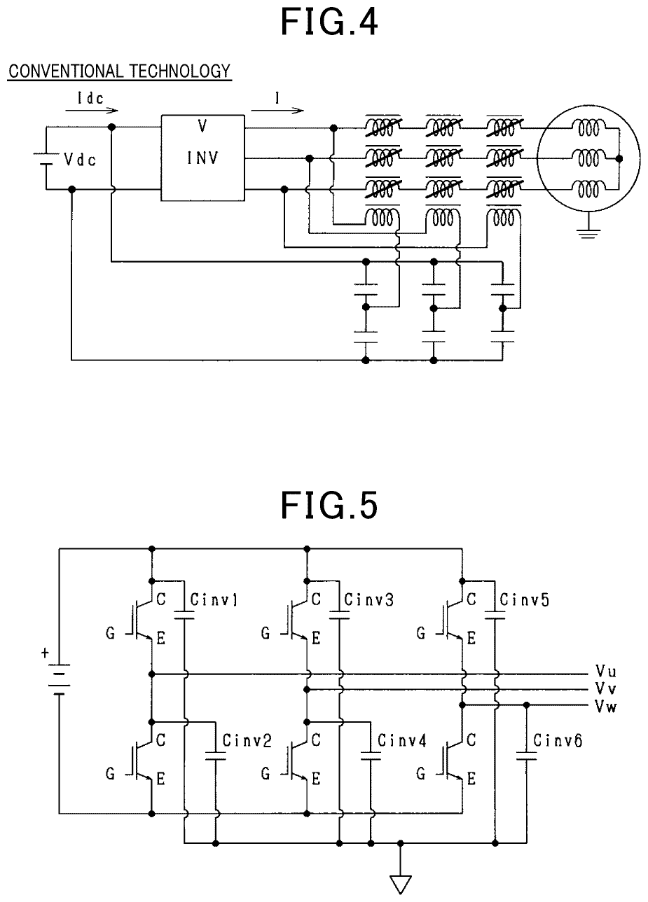

FIG. 4 is a circuit diagram of a motor drive system in the conventional technology. When an average voltage on a direct-current input side of an inverter is Vdc, a current is Idc, a line voltage of a fundamental-wave effective value on a three-phase alternating-current side of the inverter is V, a line current is I, and a power factor is cos Xθ, an expression below is obtained from a relationship with effective power P.

$$P = Vdc \cdot Idc = √ 3 \cdot V \cdot I \cdot cos θ \qquad ( 1 )$$

A maximum effective-value line voltage of inverter output is required to satisfy a relationship below.

$$Vdc > √ 2 \cdot V \qquad ( 2 )$$

From expression (1) and expression (2), a relationship below is established between the direct-current current Idc and the alternating-current effective-value current I.

$$Idc < √ ( 3 / 2 ) \cdot I \cdot cos θ \qquad ( 3 )$$

When the common-mode transformer is inserted on the direct-current side, because there are two direct-current power lines, the winding cross-sectional area of the common-mode transformer is required to be large enough to allow a current twice as large as the direct-current current Idc to flow. Meanwhile, when the common-mode transformer is inserted on the alternating-current side, because there are three phase wires (in the case of three phases), the winding cross-sectional area of the common-mode transformer is required to be large enough to allow a current three times as large as the alternating-current current to flow. An expression below is established by a comparison of Idc on the left side of expression (3) doubled and I on the right side tripled.

$$2 Idc < √ 6 I \cdot cos θ \approx 2.449 I \cdot cos θ$$

Therefore, even in cases in which alternating-current output voltage is maximum and the power factor cos θ=1, the winding cross-sectional area when the common-mode transformer is disposed on the direct-current side may be 2.449/3=0.816 times smaller than the winding cross-sectional area when the common-mode transformer is disposed on the alternating-current side. Consequently, window areas of the cores 54u, 54v, and 54w in the common-mode transformer 50 can be reduced, and the cores 54u, 54v, and 54w can be reduced in size. In an actual motor, the power factor cos θ<1, and typically cos θ=about 0.6 to 0.8. Therefore, when the common-mode transformer is disposed on the alternating-current side, the line current I is required to be further increased, and the winding cross-sectional area is required to be further increased.

This means that, according to the present embodiment, an average magnetic path length of the cores 54u, 54v, 54w can be reduced compared to the conventional technology, and excitation current can be reduced. Furthermore, if the direct-current side current is smaller than the alternating-current side current at all times, and the winding cross-sectional area be the same, loss due to winding resistance can be reduced when the common-mode transformer 50 is disposed on the direct-current side.

Next, effects caused by stray capacitance of a power semiconductor device being the same between the present embodiment and the conventional technology will be described.

In the power semiconductor device, heat dissipation fins are commonly attached to prevent overheating due to switching loss and conduction loss. The heat dissipation fins are attached directly to a device housing, and the housing is grounded. Therefore, stray capacitance is present between the device and the ground. For example, when an insulated-gate bipolar transistor (IGBT) is used as a power semiconductor device, loss in the device may mostly occur on a collector side. To efficiently dissipate this heat, the collector portion is attached so as to face a base portion of the heat dissipation fin. As a result, the stray capacitance between the device and the ground is primarily on the collector side of the IGBT.

FIG. 5 is a circuit diagram of stray capacitance of an inverter. Here, the stray capacitance of each IGBT is represented as Cinv1, Cinv2, . . . , Cinv6=c.

Only the collectors (stray capacitances Cinv2, Cinv4, Cinv6) of the three IGBTs in a lower arm are connected to the alternating-current-side terminals of the inverter. Therefore, ground stray capacitance of each phase terminal is also c. Stray capacitance of the overall alternating-current side of the inverter CAC=3c.

Meanwhile, the collectors (stray capacitances Cinv1, Cinv3, Cinv5) of the three IGBTs in an upper arm are connected to a positive terminal on the direct-current side of the inverter. The stray capacitance between the positive terminal on the direct-current side and the ground is 3c. However, because the collector of the IGBT is not connected to a negative terminal on the direct-current side of the inverter, the stray capacitance of the negative terminal on the direct-current side is zero. Therefore, stray capacitance of the overall direct-current side of the inverter CDC=3c and CAC=CDC.

Next, there being no difference in conductive electromagnetic interference (EMI) in a high frequency range between the present embodiment and the conventional technology will be described.

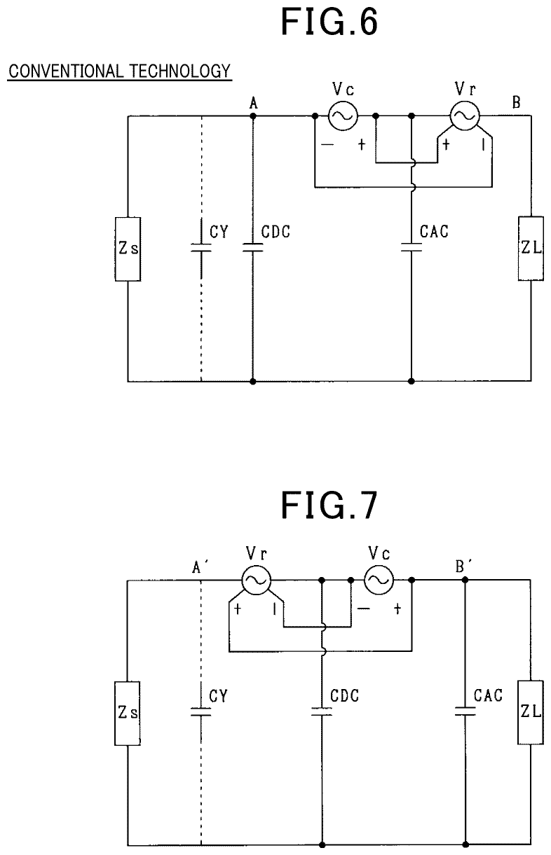

FIGS. 6 and 7 are circuit diagrams of equivalent circuits of the common-mode voltage Vc and the cancellation voltage Vr in the conventional technology and according to the present embodiment. Here, Vc represents a common-mode voltage generated by the inverter, and stray capacitances CAC and CDC are respectively inserted between the inverter and the ground on the alternating-current side and the direct-current side. ZS and ZL are common-mode impedances of the direct-current power source and the load. If the stray capacitance of the inverter is ignored, the common-mode voltage Vc generated by the inverter and the cancellation voltage Vr generated by the common-mode transformer are connected in series with reverse polarities. Therefore, the effect of the common-mode transformer is exactly the same between the conventional technology and the present embodiment.

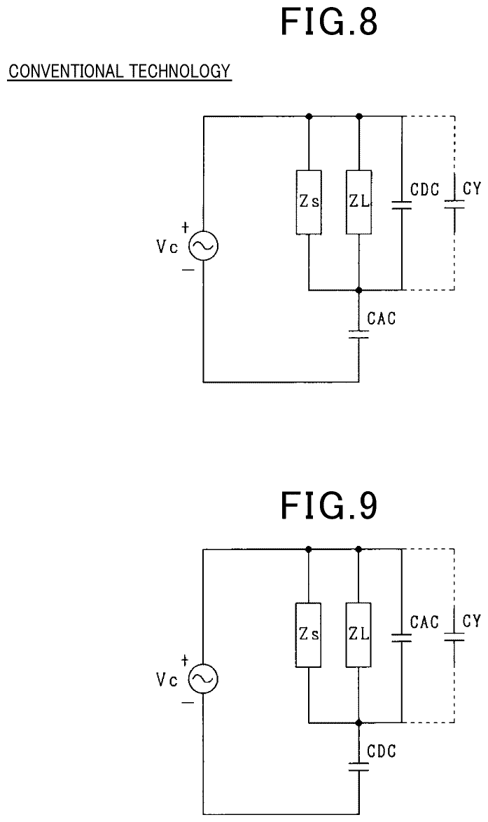

In FIGS. 6 and 7, the common-mode transformer generates the cancellation voltage Vr that has the same magnitude and reverse polarity as the common-mode voltage Vc that is generated by the inverter. Therefore, points A and B have the same potential, and points A′ and B′ have the same potential. Consequently, the equivalent circuits in FIGS. 6 and 7 can be respectively rewritten as shown in FIGS. 8 and 9.

Furthermore, because ZS and ZL include inductance components of wiring or the like in series, ZS and ZL can be ignored relative to the impedance of CAC and CDC in the high frequency range. Therefore, a voltage applied to ZS related to conductive EMI is determined by a divided voltage of CAC and CDC. Therefore, a ratio of the voltage applied to ZS when the common-mode transformer is inserted on the alternating-current side and the voltage applied to ZS when the common-mode transformer is inserted on the direct-current side is CAC/(CAC+CDC): CDC/(CAC+CDC). Here, because CAC=CDC, it is thought that there is almost no difference in conductive EMI in the high frequency range between when the common-mode transformer is inserted on the alternating-current side and when the common-mode transformer is inserted on the direct-current side.

The present embodiment described above in detail has the following advantages.

The common-mode voltage canceller 40 includes the common-mode transformer 50 that generates the cancellation voltage Vr having a polarity reverse to the common-mode voltage Vc. Therefore, the common-mode voltage Vc generated in accompaniment with the operation of the inverter 20 can be cancelled by the cancellation voltage Vr generated by the common-mode transformer 50.

The common-mode transformer 50 is disposed on the direct-current power lines 13 and 14 that supply direct-current power to the inverter 20. Therefore, even if leakage inductance is present in the common-mode transformer 50, a drop in alternating-current voltage due to leakage inductance of the common-mode transformer 50 can be suppressed. Furthermore, the direct-current power supplied by the direct-current power lines 13 and 14 is not subject to voltage drops due to leakage inductance. Therefore, a voltage utilization rate of the inverter 20 can be improved. In particular, the above-described effect is advantageous in applications in which a high-frequency-drive, low-inductance motor is used.

Whereas three phase lines are required to be passed through the core when the common-mode transformer 50 is disposed in three-phase lines in a configuration in which the inverter 30 outputs to three phase, the two direct-current power lines 13 and 14 may be passed through the cores 54u, 54v, and 54w. Therefore, the cross-sectional area of wiring to be passed through the cores 54u, 54v, and 54w can be reduced. The cores 54u, 54v, and 54w of the common-mode transformer 50 can be reduced in size.

The common-mode transformer 50 includes the primary coils 51u, 51v, and 51w to which the common-mode voltage Vc (a voltage corresponding to the common-mode voltage Vc) is input, and the secondary coils 52u, 53u, 52v, 53v, 52w, and 53w that output the cancellation voltage Vr to the direct-current power lines 13 and 14. As a result of this configuration, when the common-mode voltage Vc is generated, the cancellation voltage Vr can be outputted to the direct-current power lines 13 and 14 from the secondary coils 52u, 53u, 52v, 53v, 52w, and 53w of the common-mode transformer 50, and the common-mode voltage Vc can be cancelled.

The inverter 20 outputs alternating-current power to three phases (N phases, where N=3 in the present embodiment), and the turn ratio between the primary coils 51u, 51v, and 51w and the secondary coils 52u, 53u, 52v, 53v, 52w, and 53w is 3:1 (N:1). Therefore, the common-mode transformer 50 can generate, in the secondary coils 52u, 53u, 52v, 53v, 52w, and 53w, the cancellation voltage Vr that is ⅓ (1/N) of the voltage inputted to the primary coils 51u, 51v, and 51w and of the reverse polarity, and can cancel the common-mode voltage Vc by the cancellation voltage Vr.

The winding cross-sectional area when the common-mode transformer is disposed on the direct-current side may be smaller than that when the common-mode transformer is disposed on the alternating-current side. Therefore, the window areas of the cores 54u, 54v, and 54w of the common-mode transformer 50 can be reduced, and the cores 54u, 54v, and 54w can be reduced in size. According to the present embodiment, the average magnetic path length of the cores 54u, 54v, and 54w can be reduced compared to the conventional technology, and the excitation current can be reduced. Therefore, the common-mode transformer 50 can be reduced in size by the windings being made thinner. Alternatively, if the thicknesses of the windings are the same, loss can be reduced.

Unlike a noise filter, the common-mode voltage Vc itself is not generated (is cancelled). Therefore, radiation noise and electrocorrosion of bearings due to common current can be suppressed. Furthermore, because radiation noise is not generated, a shield for a harness (wiring) can be made unnecessary.

Here, the first embodiment can be modified in a following manner. Sections identical to those according to the above-described embodiment are given the same reference numbers. Descriptions are thereby omitted.

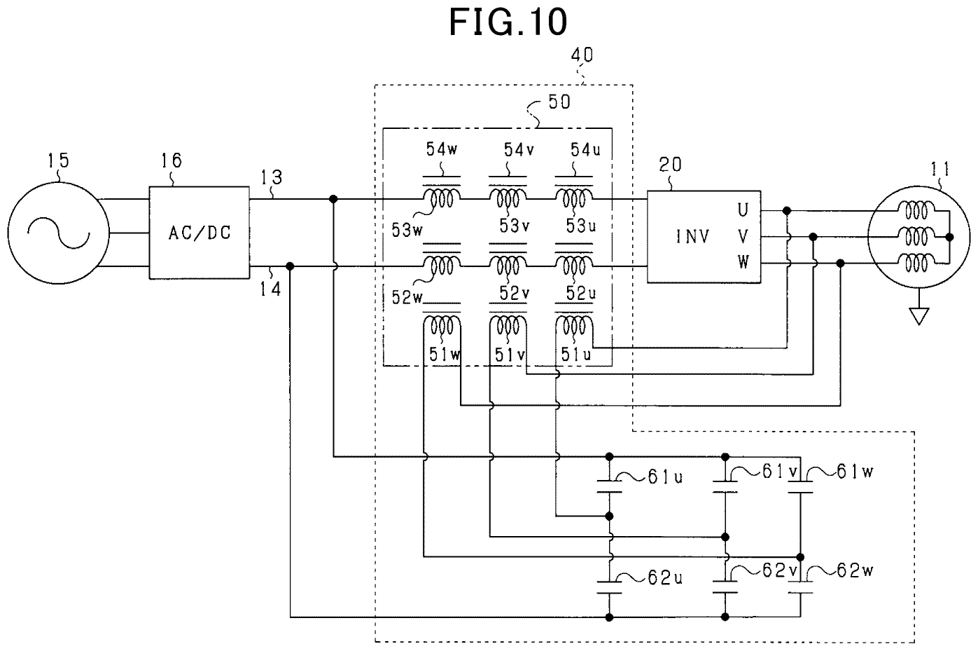

As shown in FIG. 10, a common-mode voltage canceller 40 similar to that according to the above-described embodiment can be applied to a configuration in which direct-current power is supplied to the direct-current power lines 13 and 14 from an alternating-current power source 15 through an alternating current-to-direct current (AC/DC) converter 16.

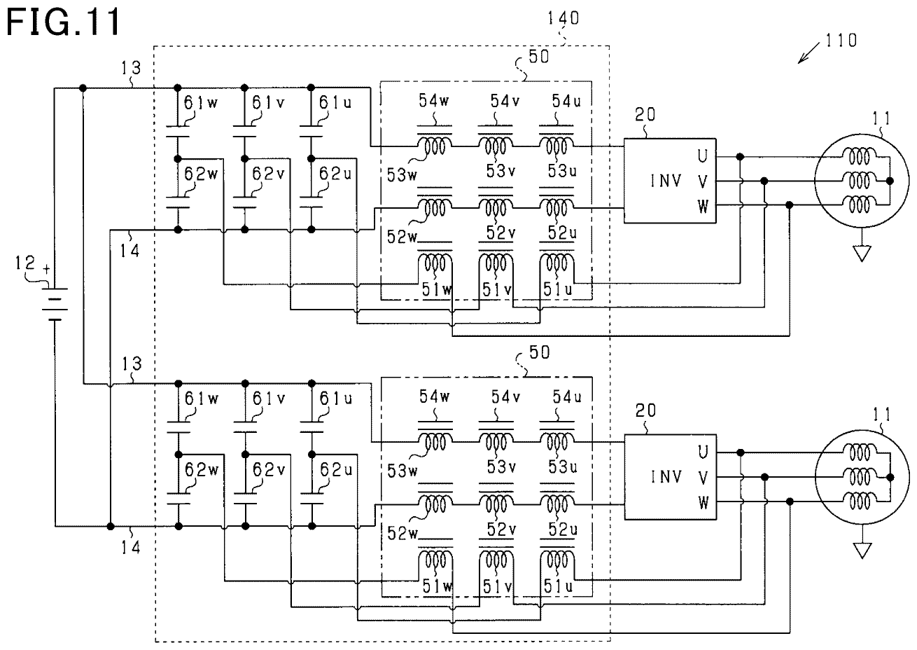

As shown in FIG. 11, a common-mode voltage canceller 140 similar to that according to the above-described embodiment can be applied to a motor drive system 110 that includes two (a plurality of) three-phase motors 11 and two (a plurality of) inverters 20.

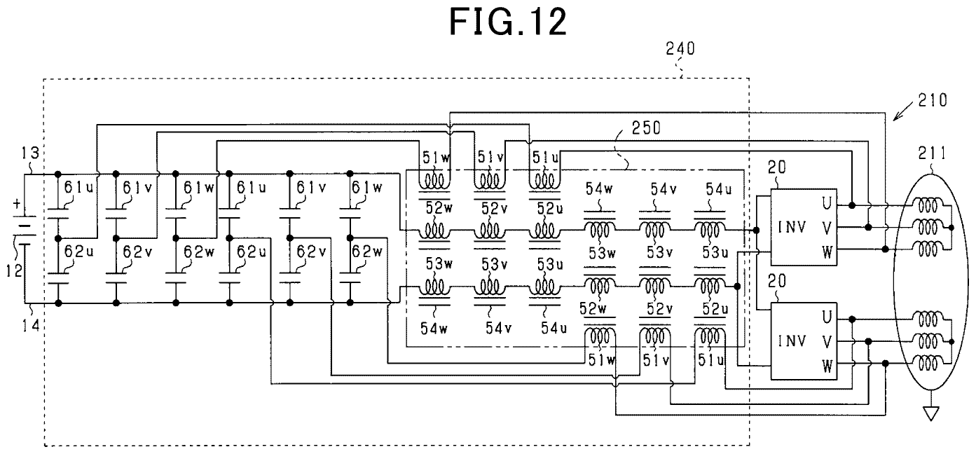

As shown in FIG. 12, a common-mode voltage canceller 240 similar to that according to the above-described embodiment can be applied to a motor drive system 210 that includes a dual winding motor 211 and two inverters 20. Carriers of the two inverters 20 are synchronous with each other and have a phase difference of 90 degrees. A common-mode transformer 250 includes transformers respectively corresponding to the two inverters 20.

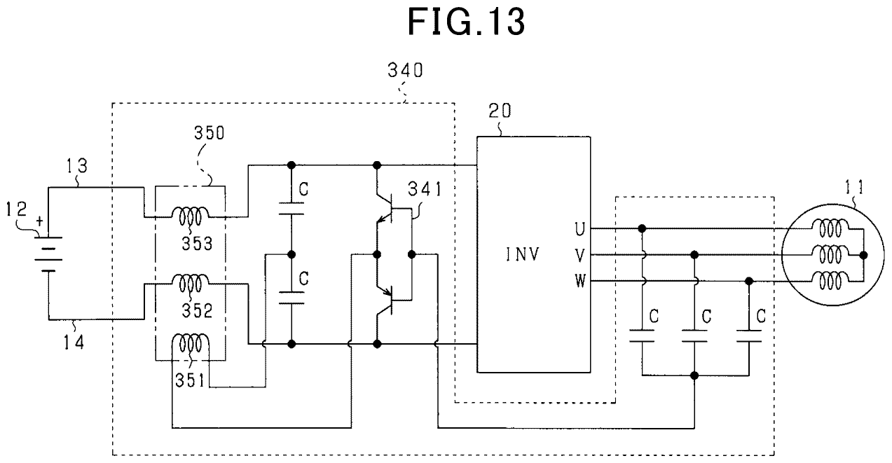

As shown in FIG. 13, in an active common-mode voltage canceller 340 described in Japanese Patent Publication No. 2863833, a configuration corresponding to that according to the above-described embodiment can be implemented by a common-mode transformer 350 being disposed on the direct-current power lines 13 and 14. The active common-mode voltage canceller 340 includes an emitter follower circuit 341 (active component), the common-mode transformer 350, a capacitor C, and the like. The common-mode transformer 350 is disposed on the direct-current power lines 13 and 14, and includes a primary coil 351 and secondary coils 352 and 353. Working effects corresponding to those according to the above-described embodiment can be achieved by a configuration such as this as well.

The above-described embodiment and modifications can be applied to motor drive systems in general that include a motor driven by an inverter.

Here, the above-described modifications can be combined.

While the present disclosure has been described with reference to embodiments thereof, it is to be understood that the disclosure is not limited to the embodiments and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

What is claimed is:

1. A common-mode voltage canceller that cancels a common-mode voltage that is generated in accompaniment with operation of an inverter that converts direct-current power to alternating-current power, the common-mode voltage canceller comprising:
a common-mode transformer that generates a cancellation voltage that has a polarity reverse to the common-mode voltage, wherein
the common-mode transformer is disposed on a direct-current power line that supplies the direct-current power to the inverter.

2. The common-mode voltage canceller according to claim 1, wherein:
the common-mode voltage canceller is a passive common-mode voltage canceller that includes a passive component connected to the common-mode transformer.

3. The common-mode voltage canceller according to claim 1, wherein:
the common-mode voltage canceller is an active common-mode voltage canceller that includes an active component connected to the common-mode transformer.

4. The common mode voltage canceller according to claim 1, wherein:
the common-mode transformer includes
a primary coil to which a voltage correlated with the common-mode voltage is input, and
a secondary coil that outputs the cancellation voltage to the direct-current power line.

5. The common mode voltage canceller according to claim 2, wherein:
the common-mode transformer includes
a primary coil to which a voltage correlated with the common-mode voltage is input, and
a secondary coil that outputs the cancellation voltage to the direct-current power line.

6. The common mode voltage canceller according to claim 3, wherein:
the common-mode transformer includes
a primary coil to which a voltage correlated with the common-mode voltage is input, and
a secondary coil that outputs the cancellation voltage to the direct-current power line.

7. The common-mode voltage canceller according to claim 4, wherein:
the inverter outputs alternating-current power to N phases; and
a turn ratio of the primary coil and the secondary coil is N:1.

8. The common-mode voltage canceller according to claim 5, wherein:
the inverter outputs alternating-current power to N phases; and
a turn ratio of the primary coil and the secondary coil is N:1.

9. The common-mode voltage canceller according to claim 6, wherein:
the inverter outputs alternating-current power to N phases; and
a turn ratio of the primary coil and the secondary coil is N:1.
